(19) United States
(12) Patent Application Publication
(10) Pub. No.: US 2008/0273944 A1
(43) Pub. Date: Nov. 6, 2008

(54) Affixing pin for dry wall or the like

(76) Inventor: Chin-Hsiung Lien, El Monte, CA (US)

Correspondence Address: DAVID AND RAYMOND PATENT FIRM, 108 N. YNEZ AVE., SUITE 128, MONTEREY PARK, CA, 91754, US

(21) Appl. No.: 11/799,788

(22) Filed: May 2, 2007

(51) Int. Cl. F16B 15/00

(52) U.S. Cl. 411/489

(57) ABSTRACT

A dry wall affixing pin, having a penetrating pin which has a penetrating tip for penetrating through a dry wall, a controlling tail coupling with the penetrating tip for determining a penetrating direction of the penetrating pin, and a force distributing surface which extends from the penetrating tip towards the controlling tail. The dry wall affixing pin also has a pusher head coupling with the controlling tail which has a grip handle and a flat pushing surface disposed at an end thereof for user to conveniently push the affixing pin into the dry wall. The force distributing surface further has a flat and peripheral surface for minimizing a contact force against materials from the dry wall while penetrating through.

### BACKGROUND OF THE PRESENT INVENTION

1. Field of Invention

The present invention relates to an affixing pin, and more particularly to an affixing pin for inserting into a dry wall and allowing the user to do so easily without applying as much pushing force as the conventional affixing pin requires.

2. Description of Related Arts

The conventional affixing pin for dry wall or the like, as shown in FIG. 1, comprises a sharp inserting head, a pin body, and a pusher handle. The sharp head is provided at a tip end of the pin body for conveniently inserting through objects such as a dry wall. It is generally extended rearwardly and conically with an increasing diameter towards the pusher handle which usually is as elongated uniform cylinder shape. The sharp tip end allows the inserting head to insert into the dry wall surface then, under a tip end pushing action, the inserting head pushes the dry wall material radially to create a hole in the dry wall for the affixing pin to further insert in it. The pusher handle couples with the penetrating body coaxially and has a flat surface at one end for user to conveniently exert force such that the inserting head can penetrate through object easier. The pusher handle of such conventional dry wall affixing pin usually has a twisting handle designed for user to grab on and allow the user to provide a twisting motion while inserting through a dry wall, thus rendering the hole-making process more efficient.

The affixing pin has been used commonly for a long time. However, most of the modifications are limited to the pusher handle part for allowing an easier or more convenient grab for the user to perform the pushing and twisting action. It is true that modification in the pusher handle may improve the inserting process but not too many modifications were ever invented on the inserting head and pin body to reduce their contact surface against the dry wall or to minimize the damage of material along an inserting path of the dry wall. A common modification on the inserting body is to add circular threads around it so that it provides a stronger twisting force when the user is twisting the pusher handle. The problem with such modification is that the manufacture cost is high and it is not too effective to use circular thread pins that have really short pin body. Also the circular threads inevitably add additional damage as the pin head is inserting through the dry wall thus allowing more space for the pin head to become loose while inside the dry wall and eventually starts to slide out and fail its function.

Many of such conventional affixing pins are used for hanging materials such as calendars, clothes, picture frame, and etc. In these applications, a hanging downward force is usually applied at the pusher handle and it creates a moment only at a pivot point at the top portion of the pin body against the dry wall. Another existing problem of such conventional affixing is that the pivot point is not strong enough for support if the affixing pin is hanging heavy materials thus creating a strong moment that might damage the dry wall or even make the pin head and body to slip out from the wall.

Another disadvantage of such conventional affixing pins is that it is allowed to rotate freely once the affixing pin is inserted into the dry wall. It is very often that the affixing pin might be experiencing different pulling or pushing forces in many different directions while hanging objects. These forces could cause the affixing pin to rotate while it is inserted into the dry wall. The rotation of the affixing pin can overcome the static friction between the pin body and the dry wall material thus allowing the pin body to slide easily inside the dry wall hole. Under this situation, the hanging affixing pin can slide out of the dry wall hole and fail the hanging objective.

### SUMMARY OF THE PRESENT INVENTION

The main object of the invention is to provide a dry wall affixing pin which requires less penetrating force for the whole affixing pin to penetrating through the wall.

Another object of the invention is to provide a dry wall affixing pin having a flat surface to minimize the reaction force applying on the pin surface when penetrating through wall.

Another object of the invention is to provide a dry wall affixing pin which can minimize the damage of wall texture when penetrating through wall.

Another object of the invention is to provide a dry wall affixing pin which the pin can function as a hanger to supportively hang objects and to provide a better hanging support.

Another object of the invention is to provide a dry wall affixing pin which is very rigid and stable against rotating force once the affixing pin is inserted into the dry wall.

Another object of the invention is to provide a dry wall affixing pin which does not involve complicated mechanical structure which can reduce the manufacture cost.

Accordingly, in order to accomplish the above objects, the present invention provides a dry wall affixing pin, comprising:
a penetrating pin, which is adapted for penetrating through the dry wall, having a sharp pin end, a controlling tail, a peripheral surface extended from the pin end to the controlling tail, and a force distributing surface which is integrally extended from the peripheral surface and is extended from the pin end towards the controlling tail, wherein the force distributing surface of the penetrating pin is adapted for minimizing a damage force against materials of the dry wall while the penetrating pin penetrating therethrough, such that when a pushing force is applied at the controlling tail for inserting the pin end of the penetrating pin into a wall surface of the dry wall to form a hole thereon, the force distributing surface is guided for sliding at a surrounding surface of the hole to minimize said pushing force to penetrate the penetrating pin through the dry wall.

These and other objectives, features, and advantages of the present invention will become apparent from the following detailed description, the accompanying drawings, and the appended claims.

### BRIEF DESCRIPTION OF THE DRAWINGS

FIG. 1A is a perspective view of an affixing pin according to a first preferred embodiment of the present invention.

FIG. 1B is a sectional view of the penetrating tip of the affixing pin according to the above first preferred embodiment of the present invention.

FIG. 2A is a perspective view of an affixing pin according to a second preferred embodiment of the present invention.

FIG. 2b is a front view of the penetrating tip of the affixing pin according to the above second preferred embodiment of the present invention.

FIG. 3 is a sectional view of the penetrating tip of the affixing pin according to the above second preferred embodiment of the present invention.

FIG. 4 illustrates an alternative mode for determining the formation of the flat surface.

FIG. 5A is a perspective view of a conventional affixing pin penetrating into a dry wall, illustrating the hanging force at the pusher head of the conventional affixing pin.

FIG. 5B is a perspective view of the affixing pin penetrating into a dry wall according to the above second embodiment of the present invention, illustrating the affixing pin enhancing the hanging force at the pusher head.

### DETAILED DESCRIPTION OF THE PREFERRED EMBODIMENT

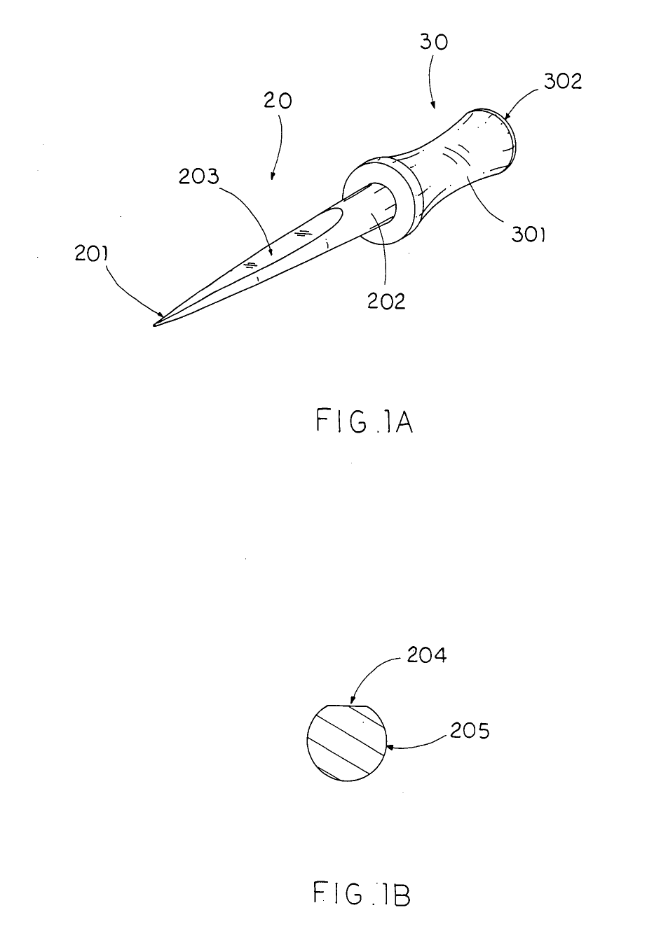

Referring to FIG. 1a of the drawings, an affixing pin comprises a penetrating pin 20 and a pusher head 30 couples to an end of the penetrating pin 20. The penetrating pin 20 further comprises a penetrating tip 201 which is designed to have a sharp tip for penetrating through object like dry wall, a controlling tail 202 which determines a penetrating direction of the penetrating pin 20, and a force distributing surface 203 extending coaxially along from the penetrating tip 201 towards the controlling tail 202.

The pusher head 30, which couples with the controlling tail 202 coaxially, further comprises a grip handle 301 and a flat pushing surface 302 disposed at an end thereof as well. The grip handle 301 and the flat pushing surface 302 are both typically in cylinder shape and the diameter of the grip handle 301 is smaller than the diameter of the flat pushing surface 302, thus leaving a cavity surrounding the grip handle 301 to allow users to place their fingers therewithin to efficiently aim the direction of which way the controlling tail 202 penetrates through. The grip handle 301 also conveniently allow users to exert a twisting and pushing force while the penetrating pin 20 is penetrating through the dry wall. After the penetrating tip has been inserted into the dry wall with a suitable depth, the user can place their thumb on the flat pushing surface 302 and provide an axial force to effectively and completely insert the affixing pin into the dry wall. Users can often hang their personal belongings like picture frame or calendar with a string attached on the cavity of the grip handle 301, thus the affixing pin can function as a hanger.

In order to solve the objectives mentioned above, the force distributing surface 203 further comprises a flat surface 204 and a peripheral surface 205. Referring to FIGS. 1a and 1b of the drawings, the flat surface 204 starts to extend at a slightly slant angle at the penetrating tip 201 portion. Then the flat surface 204 extends towards the controlling tail 202 at a flat horizontal angle. As shown in FIG. 1a and 1b of the drawings, the peripheral surface 205 is a conical surface which revolves integrally from the flat surface 204. Similar to the conventional affixing pin, the peripheral surface 205 starts as a sharp tip at a penetrating end of the penetrating tip 201 and has an increasing diameter forming a conical surface. Then the peripheral surface 205 extends toward the controlling tail 202 with a constant diameter forming a cylindrical surface. In general, the force distributing surface 203 has a constant cross section throughout except the penetrating tip 201 part with the slightly slant angle for the flat surface 204 which provides a sharper tip for penetrating through the dry wall.

The force distributing surface 203 could also be a non-arc surface comprising two edges as long as it is a surface that can reduce a contact force between the affixing pin with the dry wall materials while the affixing pin is penetrating through. The peripheral surface 205 is an arc surface having two corresponding side edges integrally extended from the two edges of the force distributing surface 203.

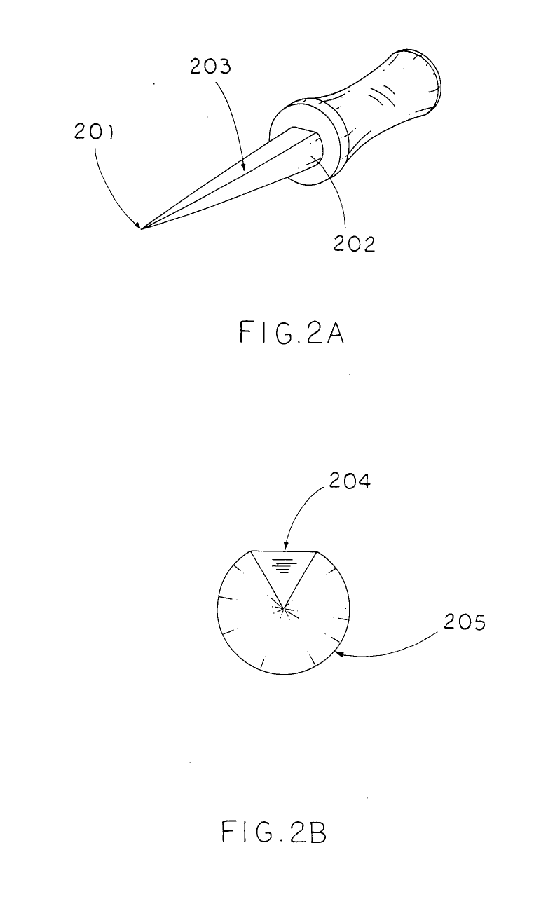

Referring to FIG. 2a and 2b of the drawings for a shorter dry wall affixing pin alternative configuration, the flat surface 204 extends from the penetrating tip 201 at a predetermined angle toward the controlling tail 202. As shown in FIG. 2a and 2b of the drawings, the peripheral surface 205 is a conical surface which revolves integrally from the flat surface 204. Similar to the conventional affixing pin, the peripheral surface 205 starts as a sharp tip at an end of the penetrating tip 201 and has an increasing diameter forming a conical surface. Then the peripheral surface 205 extends toward the controlling tail 202 with a constant diameter forming a cylindrical surface.

According to a regular or short dry wall affixing pin, the flat surface 204 is symmetric along an axis of the force distributing surface 203. A symmetric structure allows the flat surface 204 to receive an equal amount of lateral forces exerted by the dry wall material while penetrating through, thus the penetrating pin 20 is guided to penetrate straight ahead.

As the penetrating pin 20 penetrates through a dry wall, the dry wall materials are damaged by the penetrating pin 20 and forming a hole for the affixing pin insert thereinto. For the case of penetrating the conventional affixing pin through the dry wall, the dry wall materials are being damaged and pushed radially all around the penetrating head and the penetrating body. The amount of damage is determined by a contact surface between the penetrating head and body with the dry wall materials. According to the new invention, the force distributing surface 203 helps to reduce the contact surface between the dry wall materials with the flat surface 204 of the distributing surface 203. The advantage of employing the flat surface 204 is to minimize the contact force between the affixing pin with the dry wall materials because a plane surface offers the minimal surface area geometrically comparing to a cylindrical surface with the same width and diameter. As a result, less force is required for the present invention to penetrate through a dry wall as compared to conventional affixing pins. Furthermore, the present invention reduces the damage that will be done on the dry wall hole when penetrating through, thus reducing the chance of breaking the dry wall.

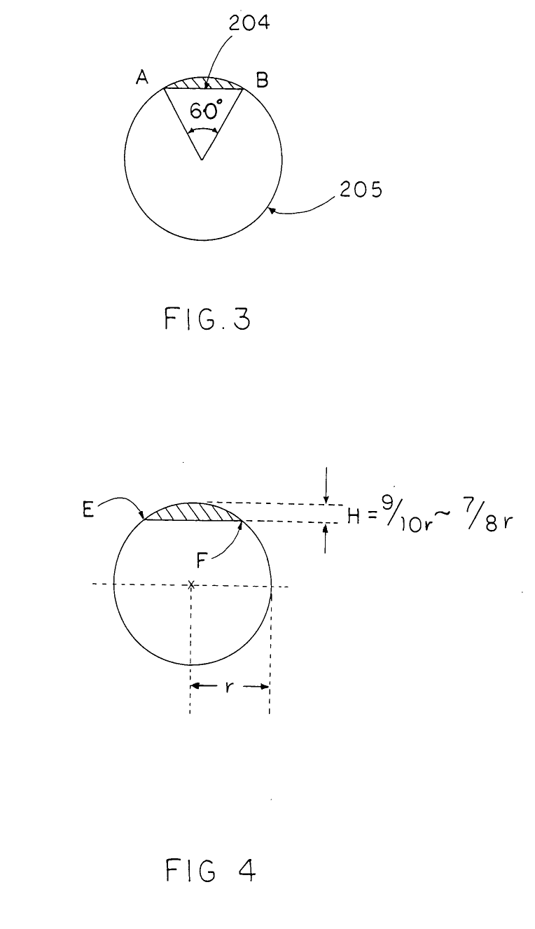

FIG. 3 of the drawings of the preferred embodiment of the invention illustrates how the flat surface 204 of the force distributing surface 203 is determined. A cross sectional area of the penetrating pin 20 is shown and point A and point B are marked at the edges by a 60 degree portion cut off the center of the penetrating pin 20. The flat surface 204 is then formed by a flat horizontal cut between point A and point B. By employing the flat surface 204 in the penetrating pin 20, the total contact force experienced by the penetrating pin 20 is reduced by 17% (60/360) comparing to the conventional affixing pin.

FIG. 4 of the drawings illustrates an alternative way of determining how the force distributing surface 203 can be measured wherein R is a radius of the penetrating pin 20 and H is a perpendicular distance between a center of the penetrating pin 20 and the force distributing surface 203. H is 9/10 to ⅞ of the radius R of the penetrating pin 20. H marks two points E and F on an outer edge circle of the penetrating pin 20. The flat surface 204 is then determined by a flat horizontal cut between point E and point F similar to method discussed above.

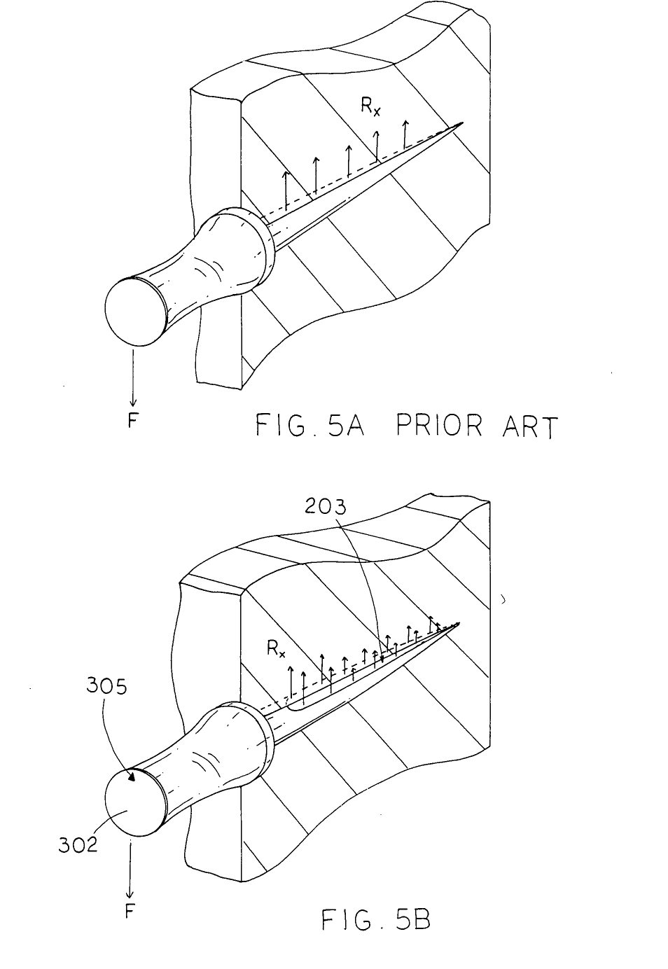

As discussed above, the affixing pin can be used has a hanger for hanging picture frames or calendars. Referring to FIG. 5 of the drawings, the affixing pin experiences a downward force (represented by a downward arrow F) from hanging objects. FIG. 6 illustrates a conventional affixing pin under the type of loading situation as shown in FIG. 5. Since the pin body of the conventional affixing pin is circular in shape, the reaction force for countering the downward force F is concentrated on a top edge along the pin body as shown in FIG. 5, thus creating a single line of high stress against a top portion of the dry wall hole.

Referring to FIG. 7 of the drawings, the affixing pin of the present invention is inserted into the a dry wall with the flat surface 204 of the force distributing surface 203 facing upward. According to this situation, the flat surface 204 of the force distributing surface 203 provides a flat horizontal surface to counter the moment created by the downward force F. The reaction force can be distributed throughout the whole of the flat surface 204 of the force distributing surface 203 as shown by the arrows R which are evenly distributed across the whole flat surface 204 of the force distributing surface 203. The flat surface 204 provides a perfect horizontal upward counter reaction force against the surface of the damaged dry wall hole. Since the counter reaction forces can be evenly and thoroughly distributed across the flat surface 204, the hanging affixing pin can reduce the possibility of creating an overloading situation which eventually leads to damaging the dry wall and making the affixing pin to fail and slip out from the dry wall hole.

As shown in FIG. 7 of the drawings, the flat pushing surface 302 of the pusher head 30 further comprises a mark 305 for indicating a direction of the force distributing surface 203. As described above, the hanging function of the affixing pin is maximized when the force distributing surface 203 is facing upward to counter against the downward hanging force F. The mark 305 helps users to conveniently identify the direction of the force distributing surface 203 when inserting the affixing pin through the dry wall.

Another advantage of the present invention is that once the affixing pin is inserted into the dry wall, it is very hard to rotate it. This is because the present invention uses the flat surface 204 which gives a non circular penetrating cross section. It is required to damage more material from the dry wall hole in order to rotate the present invention while it is inserted into the dry wall already. Therefore it is very hard to rotate the inserted affixing pin thus making the affixing pin to be safe while hanging heavy object and experiencing rotating forces.

The pusher head 30, which couples with the controlling tail 202 coaxially, further comprises a grip handle 301 and a flat pushing surface 302 disposed at an end thereof as well.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An affixing pin for a dry wall or the like, comprising a penetrating pin, which is adapted for penetrating through said dry wall, having a sharp pin end, a controlling tail, a peripheral surface extended from said pin end to said controlling tail, and a force distributing surface which is integrally extended from said peripheral surface and is extended from said pin end towards said controlling tail, wherein said force distributing surface of said penetrating pin is adapted for minimizing a damage force against materials of said dry wall while said penetrating pin penetrating therethrough, such that when a pushing force is applied at said controlling tail for inserting said pin end of said penetrating pin into a wall surface of said dry wall to form a hole thereon, said force distributing surface is guided for sliding at a surrounding surface of said hole to minimize said pushing force to penetrate said penetrating pin through said dry wall.

2. The affixing pin, as recited in claim 1, wherein said force distributing surface is a non-arc surface extended from said pin end of said penetrating pin to said controlling tail thereof.

3. The affixing pin, as recited in claim 1, wherein said force distributing surface is a flat surface extended from said pin end of said penetrating pin towards said controlling tail thereof.

4. The affixing pin, as recited in claim 1, wherein said peripheral surface is an arc surface having two corresponding side edges integrally extended from two edges of said force distributing surface respectively.

5. The affixing pin, as recited in claim 3, wherein said peripheral surface is an arc surface having two corresponding side edges integrally extended from two edges of said force distributing surface respectively.

6. The affixing pin, as recited in claim 1, wherein a width of said force distributing surface is 60° radially projected from a center of said penetrating pin.

7. The affixing pin, as recited in claim 2, wherein a width of said force distributing surface is 60° radially projected from a center of said penetrating pin.

8. The affixing pin, as recited in claim 5, wherein a width of said force distributing surface is 60° radially projected from a center of said penetrating pin.

9. The affixing pin, as recited in claim 1, wherein a perpendicular distance between a center of said penetrating pin and said force distributing surface is 9/10 to ⅞ of a radius of said penetrating pin.

10. The affixing pin, as recited in claim 2, wherein a perpendicular distance between a center of said penetrating pin and said force distributing surface is 9/10 to ⅞ of a radius of said penetrating pin.

11. The affixing pin, as recited in claim 5, wherein a perpendicular distance between a center of said penetrating pin and said force distributing surface is 9/10 to ⅞ of a radius of said penetrating pin.

12. The affixing pin, as recited in claim 3, wherein said penetrating pin has an increasing diameter extended from said pin end to said controlling tail, wherein said force distributing surface is extended from said pin end to a position close to said controlling tail.

13. The affixing pin, as recited in claim 8, wherein said penetrating pin has an increasing diameter extended from said pin end to said controlling tail, wherein said force distributing surface is extended from said pin end to a position close to said controlling tail.

14. The affixing pin, as recited in claim 11, wherein said penetrating pin has an increasing diameter extended from said pin end to said controlling tail, wherein said force distributing surface is extended from said pin end to a position close to said controlling tail.

15. The affixing pin, as recited in claim 3, wherein said penetrating pin has a uniform diameter extended from said pin end to said controlling tail, wherein said force distributing surface is extended from said pin end to said controlling tail.

16. The affixing pin, as recited in claim 8, wherein said penetrating pin has a uniform diameter extended from said pin end to said controlling tail, wherein said force distributing surface is extended from said pin end to said controlling tail.

17. The affixing pin, as recited in claim 11, wherein said penetrating pin has a uniform diameter extended from said pin end to said controlling tail, wherein said force distributing surface is extended from said pin end to said controlling tail.

18. The affixing pin, as recited in claim 1, further comprising a pusher head coupling with said controlling end of said penetrating pin, wherein said pusher head has a grip handle, a flat pushing surface formed at a rear end thereof, and an indicating mark provided on said pushing surface to indicate a location of said force distributing surface.

19. The affixing pin, as recited in claim 12, further comprising a pusher head coupling with said controlling end of said penetrating pin, wherein said pusher head has a grip handle, a flat pushing surface formed at a rear end thereof, and an indicating mark provided on said pushing surface to indicate a location of said force distributing surface.

20. The affixing pin, as recited in claim 15, further comprising a pusher head coupling with said controlling end of said penetrating pin, wherein said pusher head has a grip handle, a flat pushing surface formed at a rear end thereof, and an indicating mark provided on said pushing surface to indicate a location of said force distributing surface.
